(19) United States
(12) Patent Application Publication
(10) Pub. No.: US 2012/0037841 A1
(43) Pub. Date: Feb. 16, 2012

(54) Ecological, Biodegradable, Fluid Lubricant And Anti-Freezing Composition For Hydraulic Systems

(75) Inventor: Roberto Andrade Galváo, Sao Paulo (BR)

(73) Assignee: Promax Products <aximos S/A Industria E. Comercio, Sao Paulo (BR)

(21) Appl. No.: 13/201,746

(22) PCT Filed: Feb. 12, 2010
(86) PCT No.: PCT/BR10/00048

§ 371 Date: Sep. 21, 2011

(30) Foreign Application Priority Data
Feb. 17, 2009 (BR) P10900280-4

(51) Int. Cl. C09K 5/20

(52) U.S. Cl. 252/68

(57) ABSTRACT

An ECOLOGICAL, BIODEGRADABLE, FLUID LUBRICANT AND ANTI-FREEZING COMPOSITION FOR HYDRAULIC SYSTEMS, contains: a base oil of Group V, such as adipic acid diesters, an anti-oxidising additive such as diphenylamines, and an antifoaming additive, such as a silicone-free combination of hydrocarbons, vegetable fatty acids and glycols.

This invention patent is related to a new composition of lubricant fluid for hydraulic systems, including shock absorbers, which results on an environment friendly, biodegradable, anti-freezing fluid, keeping all physical and chemical features critical to its good work in compliance with the safety and good performance technical standards.

As known by the technique, fluids for hydraulic systems (among them, fluids for shock absorbers) available in the market have, in their composition and as their main component, mineral base oil or a mix of mineral base oils.

However, the biodegradability of those components is considered low, i.e, “not easily biodegradable”, so the elimination of that material has to be performed as per CONAMA resolution 362.

It is an aim of this invention to produce a lubricant fluid composition with biodegradability higher than the products currently available in the marketing and that can thereafter be sent to treatment stations for products considered as “easily biodegradable”, being therefore eliminated in a way other than that established in the aforementioned resolution.

It is another aim of this invention to obtain a lubricant fluid that works at the lowest temperatures (below −45° C.), a factor that makes this product a universal use product, avoiding the need for stocking several others products.

For such, according to this invention, this innovated lubricant fluid comprises:

a) larger amount of Group V base oil, such as adipic acid diesters, azelaic acid diesters, phtalic acid diesters, other acids diesters; vegetable esters, other esters; polyalkylene glycols; others Group IV and V base oils, preferring with cinematic viscosity from 2 cSt to 8 cSt at 100° C.; vegetable oils; biodiesel; which has the aim to give the fluid biodegradability, lubricant and anti-freezing features; due to its biodegradability features, the fluid can be sent to treatment stations for products considered as “easily biodegradable” and may be universally utilized because it also works at low temperatures (even below −45° C.);
b) a smaller amount of antioxidant additive, such as diphenylamines; zinc dithiophosphate; alkylate triphenyl phosphorothionate; other phosphorized sulfur compositions; the antioxidant additive has the aim to avoid the end product (fluid) aging due oxidation by the action of the oxygen in the air and high temperatures (generally 100° C. with 140° C. peak) during work regimen;
c) an antifoaming, such as silicone-free combination of hydrocarbons, vegetable fatty acids and glycols; silicon fluid; dimethicone; polydimethylsiloxane; polydimethylsiloxane water solutions; the antifoaming is to avoid the foaming resulting from air intake in the system during work regimen; foam causes lubrication failures and therefore should be avoided.

The subject of this Invention Patent is an “ECOLOGICAL, BIODEGRADABLE, FLUID LUBRICANT AND ANTI-FREEZING COMPOSITION FOR HYDRAULIC SYSTEMS”, comprising:

a) Group V base oil, such as adipic acid diester, azelaic acid diesters, phtalic acid diesters, other acid diesters; vegetable esters; other esters; polyalkylene glycols; other Group IV and V base oils; vegetable oils; biodiesel; with 94.9950% to 99.8999% mass rate, 98.99875% preferred.
b) antioxidant additive, such as diphenylamines; zinc dithiophosphate; alkylate triphenyl phosphorothionate; other phosphorized sulfur compositions; with 0.1 to 5% mass rate, 1% preferred;
c) antifoaming; such as hydrocarbon packet, vegetable fatty acids and glycols, free from silicon; silicon fluid; dimethicone; polydimethylsiloxane; polydimethylsiloxane water solution; with 0.00001% to 0.00500% mass rate, 0.00125% preferred.

This innovated lubricant fluid has the following working and performance specifications, i.e, the following physical and chemical features: clear visual aspect; 2.0 ASTM maximum color index; cinematic viscosity from 2 cSt to 10 cSt at 100° C.; 100 minimum viscosity index; 150° C. minimum flash point; minus 45° C. maximum flow point; and 2mg KOH/g maximum acidity index.

1) ECOLOGICAL, BIODEGRADABLE, FLUID LUBRICANT AND ANTI-FREEZING COMPOSITION FOR HYDRAULIC SYSTEMS, characterized by comprising: a) Group V base oil at 94.9950% to 99.8999% mass rate, 98. 99875% preferred; b) antioxidant additive at 0.1% to 5% mass rate, 1% preferred; c) antifoaming at 0.00001% to 0.00500% mass rate, 0.00125% preferred.

2) ECOLOGICAL, BIODEGRADABLE, FLUID LUBRICANT AND ANTI-FREEZING COMPOSITION FOR HYDRAULIC SYSTEMS, according to claim 1, characterized by the Group V base oil being adipic acid diesters, azelaic acid diesters, phtalic acid diesters, other acid diesters; vegetable esters; other esters; polyalkylene glycols; other Group IV and V base oils; vegetable oils; biodiesel.

3) ECOLOGICAL, BIODEGRADABLE, FLUID LUBRICANT AND ANTI-FREEZING COMPOSITION FOR HYDRAULIC SYSTEMS, according to claim 1, characterized by the antioxidant additive being diphenylamines; zinc dithiophosphate; alkylate triphenyl phosphorothionate; other phosphorized sulfur compositions.

4) ECOLOGICAL, BIODEGRADABLE, FLUID LUBRICANT AND ANTI-FREEZING COMPOSITION FOR HYDRAULIC SYSTEMS, according to claim 1, characterized by the antifoaming being hydrocarbon packet, vegetable fatty acids and glycols, free from silicon; silicon fluid; dimethicone; polydimethylsiloxane; polydimethylsiloxane water solution.

5) ECOLOGICAL, BIODEGRADABLE, FLUID LUBRICANT AND ANTI-FREEZING COMPOSITION FOR HYDRAULIC SYSTEMS, according to claim 1, characterized by cinematic viscosity from 2 cSr to 10 cSt at 100° C.

6) ECOLOGICAL, BIODEGRADABLE, FLUID LUBRICANT AND ANTI-FREEZING COMPOSITION FOR HYDRAULIC SYSTEMS, according to claim 1, characterized by 100 minimum cinematic viscosity.

7) ECOLOGICAL, BIODEGRADABLE, FLUID LUBRICANT AND ANTI-FREEZING COMPOSITION FOR HYDRAULIC SYSTEMS, according to claim 1, characterized by 150° C. minimum flash point.

8) ECOLOGICAL, BIODEGRADABLE, FLUID LUBRICANT AND ANTI-FREEZING COMPOSITION FOR HYDRAULIC SYSTEMS, according to claim 1, characterized by 45° C. maximum flow point.

9) ECOLOGICAL, BIODEGRADABLE, FLUID LUBRICANT AND ANTI-FREEZING COMPOSITION FOR HYDRAULIC SYSTEMS, according to claim 1, characterized by 2 mg KOH/g maximum acidity index.
